(19) United States
(12) Patent Application Publication
(10) Pub. No.: US 2025/0310183 A1
(43) Pub. Date: Oct. 2, 2025

(54) END-TO-END IMS NETWORK SLICING

(71) Applicant: Verizon Patent and Licensing Inc., Basking Ridge, NJ (US)

(72) Inventors: John Cao Vinh Nguyen, Trophy Club, TX (US); Vivek Dilipbhai Patel, Chesterfield, NJ (US); Bibi M. Hakimzadeh, Fort Worth, TX (US); Toby Varughese John, Murphy, TX (US)

(21) Appl. No.: 18/617,823

(22) Filed: Mar. 27, 2024

(51) Int. Cl. H04L 41/0806; H04L 65/1016

(52) U.S. Cl. CPC H04L 41/0806; H04L 65/1016

(57) ABSTRACT

An Internet Protocol (IP) Multimedia Subsystem (IMS) network slice manager and orchestrator receives first performance requirements associated with a first network slice of a mobile network. The IMS network slice manager and orchestrator determines, based on the first performance requirements, first configuration data associated with a first IMS network slice of an IMS network, where the first IMS network slice is linked to the first network slice of the mobile network. The IMS network slice manager and orchestrator configures and provisions, based on the first configuration data, the first IMS network slice in the IMS network.

### BACKGROUND

The Internet Protocol (IP) multimedia subsystem (IMS), defined by the 3rd Generation Partnership Project (3GPP) and other network standard entities, is an architectural framework for implementing IP-based telephony and multimedia services. IMS defines a set of specifications that enables the convergence of voice, video, data, and mobile technology over an all IP-based network infrastructure. In particular, IMS fills the gap between the two most successful communication paradigms-cellular and Internet technology, by providing Internet services everywhere using cellular technology in a more efficient way. Session Initiation Protocol (SIP) is the main protocol for IMS. SIP is an application layer control (signaling) protocol for creating, modifying and terminating sessions with one or more participants.

### BRIEF DESCRIPTION OF THE DRAWINGS

FIG. 1 depicts an exemplary network environment in which IMS network slicing may be implemented;

FIG. 2 illustrates example components of a mobile network;

FIG. 3 illustrates an example of interfacing between a mobile network and network elements of an IMS network;

FIG. 4 illustrates an example of the implementation of network slices in a mobile network;

FIG. 5 depicts an example of the implementation of network slices in an IMS network;

FIG. 6 illustrates example components of a mobile network slice manager and orchestrator;

FIG. 7 is a diagram that depicts example components of a network device;

FIG. 8 is a flow diagram of an example process for implementing a network slice in a mobile network and a corresponding, linked network slice in an IMS network;

FIG. 9 is a flow diagram of example details of the mobile network slice manager and orchestrator configuring and provisioning a mobile network slice;

FIG. 10 is a flow diagram of example details of the IMS network slice manager and orchestrator configuring and provisioning an IMS network slice;

FIG. 11 illustrates an example of a mapping configuration table for a generic network element within an IMS network slice;

FIG. 12 illustrates multiple examples of IMS network slices linked to, and designed to service traffic associated with, particular mobile network slices;

FIGS. 13A-13D illustrate examples of mapping configuration tables associated with some of the network elements of the IMS network slices of FIG. 12; and

FIG. 14 depicts an example of a messaging diagram associated with establishing Vehicle Emergency Call Service via an IMS network slice.

### DETAILED DESCRIPTION

The following detailed description refers to the accompanying drawings. The same reference numbers in different drawings may identify the same or similar elements. The following detailed description does not limit the invention.

“Network Slicing” is an innovation for implementation in Next Generation Mobile Networks, such as, for example, Fifth Generation New Radio (5G NR) Mobile Networks, and represents a key benefit of Next Generation wireless network architectures. Network slicing is a type of virtualized networking architecture that involves partitioning of a single physical network into multiple virtual networks that include various Virtual Network Functions (VNFs) and/or Cloud-Native Network Functions (CNFs). VNFs include network functions that have been moved out of dedicated hardware devices into software that runs on commodity hardware. VNFs may be executed as one or more Virtual Machines (VMs) on top of the hardware networking infrastructure. CNFs include software implementations of functions that typically execute in a containerized environment. The partitions or “slices” of a virtualized network, including each slice's VNFs and CNFs, may be customized to meet the specific needs of applications, services, devices, customers, or operators. Each network slice can have its own architecture, provisioning management, and security that supports data sessions transported over the network slice. Bandwidth, capacity, and connectivity functions are allocated within each network slice to meet the requirements of the objective of the particular network slice. For example, each network slice, when created in a mobile network, may be designed to satisfy one or more performance characteristics or performance requirements for data sessions that are serviced by the network slice. Network slicing may be implemented in a dynamic fashion, such that the slices of the virtualized network may change over time and may be re-customized to meet new or changing needs of applications, services, devices, customers, or operators.

Though Next Generation networks currently provide mechanisms for network slicing in which traffic is separated into multiple logical networks on a same common physical infrastructure, there is currently no end-to-end mechanism of network slicing for the overall IMS network. As described herein, new mechanisms are provided for creating network slicing in the IMS network. Customization of network slicing in the IMS network enables the IMS network to cater to specific needs, and performance requirements, of different network users. Each IMS network slice may have its own configuration of IMS network elements (NEs) that may be dynamically reconfigured. Network slicing of the IMS network will provide many benefits, including reducing operational and capital expenses due to the ability to build a leaner network, and utilizing the finite virtualized IMS network resources more efficiently. Benefits of network slicing of the IMS network further include providing unique Quality of Service (QOS) requirements specific to the service(s) being offered, scaling of application services in an IMS network slice based on demand, enabling flexibility in deployment including expedited introduction of new services and capabilities, customizing each IMS network slice based on the customer's requirements (e.g., priority requirements, service availability, reliability requirements), simplifying maintenance of the IMS network, and enabling new configurations and/or new NEs to be deployed quickly to assist in reducing outages.

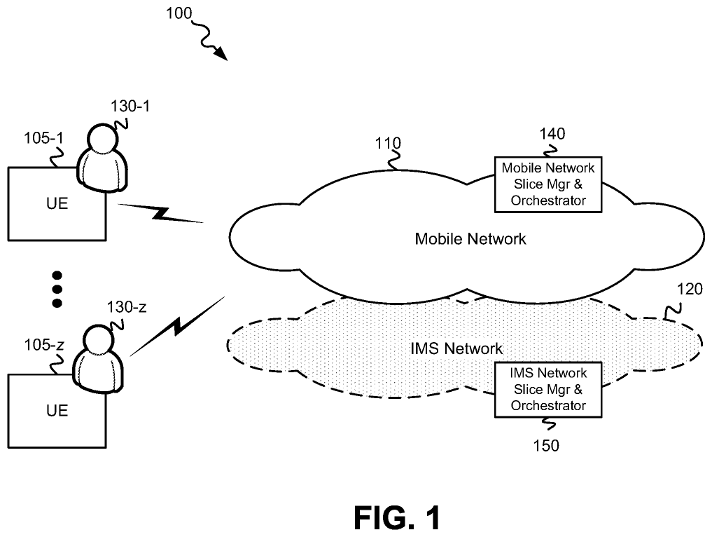

FIG. 1 depicts an exemplary network environment 100 in which IMS network slicing may be implemented. As shown, network environment 100 includes User Equipment devices (UEs) 105-1 through 105-z, a mobile network 110, and an IMS network 120. UEs 105-1 through 105-z (referred to herein as “UE 110” or “UEs 110”) may each include any type of electronic device having a wireless communication capability. Though only two UEs 105 are shown, network environment 100 may include numerous UEs (e.g., z>>2). UE 105 may include, for example, a laptop, palmtop, desktop, or tablet computer; a cellular phone (e.g., a “smart” phone); a Voice over Internet Protocol (VOIP) phone; a smart television (TV); an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user (also referred to herein as a “subscriber”) may carry, use, administer, and/or operate each UE 105. For example, as shown, a first user 130-1 may operate UE 105-1 and a second user 105-z may operate UE 105-z. UEs 105 may each execute a respective Session Initiation Protocol (SIP) user agent (UA) (not shown) that may establish connections and sessions with other UEs 105 via IMS network 120. Protocols other than SIP may be used for call control and session establishment.

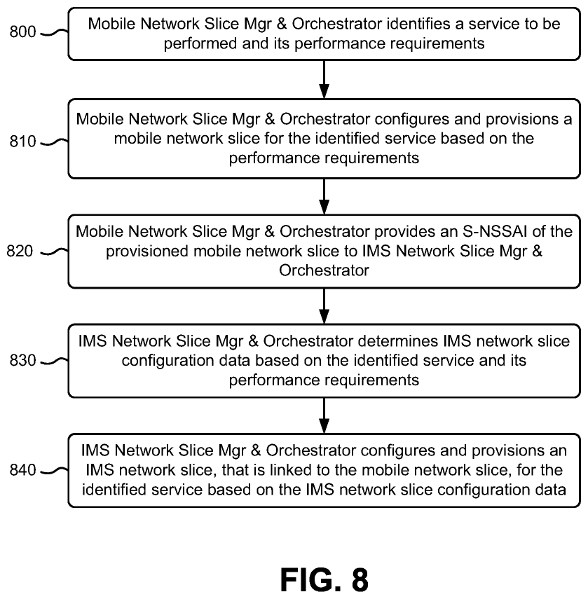

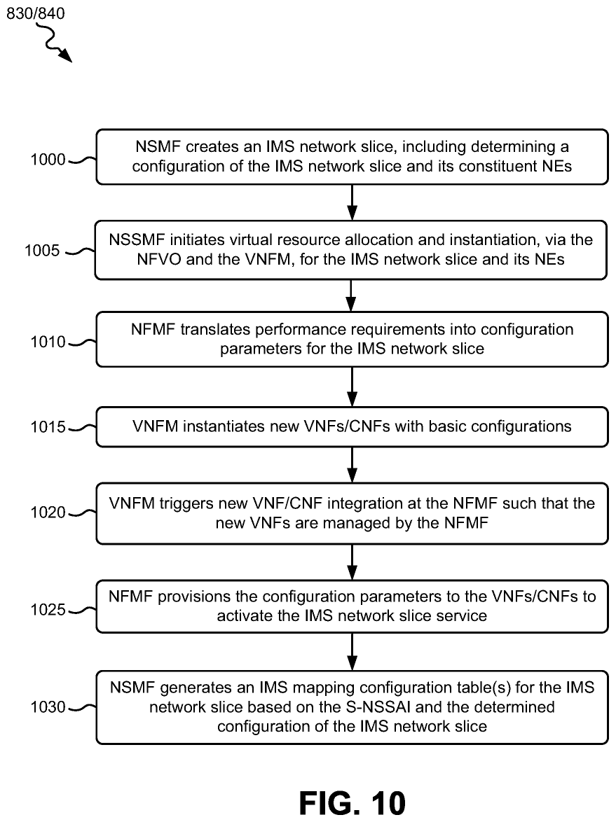

Mobile network 110 (also referred to herein as “wireless network 110” or “network 110”) may include any type of a Public Land Mobile Network (PLMN). In some implementations, mobile network 110 may include any type of a Next Generation mobile network that includes evolved network components (e.g., future generation components) relative to a Long-Term Evolution (LTE) network, such as a Fourth Generation (4G) or 4.5G mobile network. For example, mobile network 110 may include a 5G mobile network. As shown in FIG. 1, mobile network 110 may include a mobile network Slice Manager (Mgr) & Orchestrator 140 that implements network slicing within mobile network 110. Mobile Network Slice Mgr & Orchestrator 140 may perform, among other operations and functions, mobile network slice and Network Slice Instance (NSI) creation, virtual network resource allocation, instantiation, and provisioning, and mobile network slice and MN NSI monitoring, reporting, and life cycle management (LCM). Example operations performed by Mobile Network Slice Mgr & Orchestrator 140 are described below with respect to FIGS. 8 and 10.

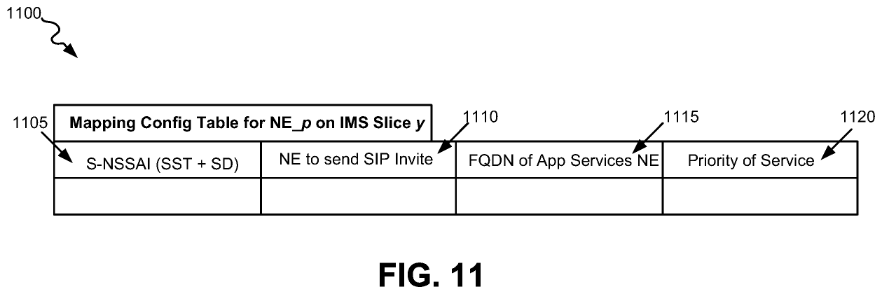

IMS network 120 includes a network that uses SIP for voice and multimedia session control, such as for creating, modifying, and terminating sessions between devices, such as between UEs 105, or between UEs 105 and other endpoints. As further shown in FIG. 1, IMS network 120 may include an IMS Network Slice Mgr & Orchestrator 150 that, similar to Mobile Network Slice Mgr & Orchestrator 140, implements network slicing within IMS network 120. IMS Network Slice Mgr & Orchestrator 150 may perform, among other operations and functions, IMS network slice creation, virtual network resource allocation, instantiation, and provisioning, and IMS network slice monitoring, reporting, and life cycle management (LCM). Example operations performed by IMS Network Slice Mgr & Orchestrator 150 are described below with respect to FIGS. 8 and 11. In implementations in which they are separate entities, Mobile Network Slice Mgr & Orchestrator 140 and IMS Network Slice Mgr & Orchestrator 150 may communicate with one another via, for example, mobile network 110, IMS network 120, or a data network (not shown), such as the Internet.

In the example network environment 100 of FIG. 1, Mobile Network Slice Mgr & Orchestrator 140 and IMS Network Slice Mgr & Orchestrator 150 are shown as two separate entities residing in different networks. In some implementations, however, the operations and functions of Mobile Network Slice Mgr & Orchestrator 140 and IMS Network Slice Mgr & Orchestrator 150 may be performed by a single network device, platform, system, or other type of centralized configuration that may be located in mobile network 110, IMS network 120, or in another network not shown in FIG. 1 (e.g., the Internet).

The configuration of network components of network environment 100 is shown in FIG. 1 is for illustrative purposes. Other configurations may be implemented. Therefore, network environment 100 may include additional, fewer, and/or different components that may be configured in a different arrangement than that depicted in FIG. 1. For example, mobile network 110 and/or IMS network 120 may connect to one or more other types of networks, such as, for example, local area networks (LANs), wide area networks (WANs), metropolitan area networks (MANs), Public Switched Telephone Networks (PSTNs), and/or the Internet.

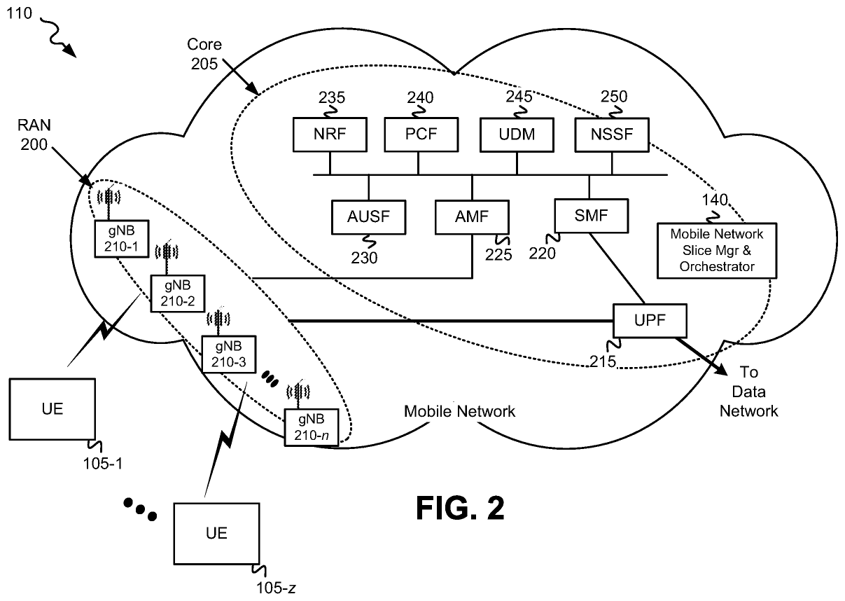

FIG. 2 depicts example components of mobile network 110. As shown, mobile network 110 may include sub-networks, such as a Radio Access Network (RAN) 200 and a mobile core network 205. RAN 200 may include various types of radio access equipment that enable Radio Frequency (RF) communication with UEs 105. The radio access equipment of RAN 200 may include, for example, multiple Next Generation NodeBs (gNBs) 210-1 through 210-n (also referred to as “base stations”). Each gNB 210 may include a Centralized Unit (CU) (not shown), multiple Distributed Units (DUs) (not shown), and multiple Radio Units (RUs) (not shown).

Each CU of a gNB 210 includes a network device that operates as a digital function unit that transmits digital baseband signals to the multiple DUs of the gNB 210, and receives digital baseband signals from the multiple DUs of the gNB 210. The DUs perform centralized processing and coordination of multiple Rus of the gNB 210, handles tasks such as scheduling and overall control of the radio resources, and interfaces with the core NFs to establish and manage connections with UEs 105 and to facilitate communication between different cells. The RUs of a gNB 210 may include network devices, that may be located at fixed geographic positions within mobile network 110, and operate as radio function units that transmit and receive RF signals to/from UEs 105. Each CU 210 of a gNB 210 may interconnect with the DUs of the gNB 210 via fronthaul links or a fronthaul network. Each of the RUs may include at least one antenna array, transceiver circuitry, and other hardware and software components for enabling the DUs to receive data via wireless RF signals from UEs 105, and to transmit wireless RF signals to UEs 105. Each RU of a gNB 210 further connects to a respective DU of the gNB 210 that may serve as a coordinator for multiple RUs.

In other implementations, one or more of the gNBs 210 of RAN 200 may instead be an evolved NodeB (eNB), which may also be referred to herein as a “base station.” RAN 200 may additionally include other nodes, functions, and/or components not shown in FIG. 2.

Core network 205 includes devices or nodes that host and execute network functions (NFs) that operate the mobile network 110 including, among other NFs, mobile network access management, session management, and policy control NFs. In the example network environment 100 of FIG. 2, core network 205 is shown as including 5G NFs, such as a User Plane Function (UPF) 215, a Session Management Function (SMF) 220, an Access and Mobility Management Function (AMF) 225, an Authentication Service Function (AUSF) 230, a Network Repository Function (NRF) 235, a Policy Control Function (PCF) 240, a Unified Data Management (UDM) function 245, and a Network Slice Selection Function (NSSF) 250. UPF 215, SMF 220, AMF 225, AUSF 230, NRF 235, PCF 240, UDM 245, and NSSF 250 may be implemented as VNFs or CNFs (e.g., at a data center(s)) within mobile network 110). Core network 205 is further shown as including Mobile Network Slice Mgr & Orchestrator 140.

UPF 215 may act as a router and a gateway between mobile network 110 and an external data network (not shown), and forwards session data between the external data network and RAN 200. UPF 215 may further act as a router and a gateway between user plane NEs of IMS network 120 and RAN 200, and between control plane NEs of IMS network 120 and RAN 200. Though only a single UPF 215 is shown in FIG. 2, mobile network 110 may include multiple UPFs 215 at various locations in mobile network 110. SMF 220 performs session management and selects and controls UPFs 215 for data transfer. AMF 225 performs mobility management for the UEs 105.

AUSF 230 may implement authentication and security key management functions for authorizing UE access to mobile network 110 and for establishing secure connections. AUSF 230 further interacts with AMF 225 to manage subscriber mobility and handover procedures, supports session management, and interacts with UDM 245 to manage subscriber data and profiles.

NRF 235 operates as a centralized repository of information regarding NFs in mobile network 110. NRF 235 enables NFs (e.g., UPF 215, SMF 220, AMF 225, PCF 240, UDM 245, NSSF 250) to register and discover each other via an Application Programming interface (API). NRF 235 maintains an updated repository of information about the NFs available in mobile network 110, along with information about the services provided by each of the NFs. NRF 235 further enables the NFs to obtain updated status information of other NFs in mobile network 110. NRF 235 may, for example, maintain profiles of available NF instances and their supported services, allow NF instances to discover other NF instances in mobile network 110, and allow NF instances to track the status of other NF instances.

PCF 240 may provide policy rules for control plane functions (e.g., for network slicing, roaming, and/or mobility management) and may access user subscription information for policy decisions. UDM 245 manages data for user access authorization, user registration, and data network profiles. UDM 245 may include, or operate in conjunction with, a User Data Repository (UDR—not shown) which stores user data, such as customer profile information, customer authentication information, user-subscribed network slice information, and encryption keys. NSSF 250 may obtain NSI and network slicing configuration information from Mobile Network Slice Mgr & Orchestrator 140 and may select a set of network slice instances that may serve a UE session and may determine the allowed single Network Slice Selection Assistance Information (S-NSSAI) for the UE session.

The configuration of network components of the example mobile network 110 of FIG. 2 is for illustrative purposes. Other configurations may be implemented. Therefore, mobile network 110 may include additional, fewer, and/or different components that may be configured in a different arrangement than that depicted in FIG. 2. For example, core network 205 may include other NFs not shown in FIG. 2. As a further example, though mobile network 110 is depicted in FIG. 2 as a 5G network having 5G network components/functions, mobile network 110 may alternatively include a 4G or 4.5G network with corresponding network components/functions, or a hybrid 5G/4G network that includes certain components of both a Next Generation network (e.g., a 5G network) and a 4G Long Term Evolution (LTE) network. Mobile network 110 may alternatively include another type of Next Generation network, other than the 5G network shown in FIG. 2 (e.g., a Sixth Generation (6G) mobile network).

Additionally, though only a single instance of each of the NFs (e.g., UPF 215, SMF 220, AMF 225, AUSF 230, NRF 235, PCF 240, UDM 245, NSSF 250) is shown in FIG. 2, mobile network 110 may include multiple instances of each of the NFs. For example, when Mobile Network Slice Mgr & Orchestrator 140 implements mobile network slicing, each of the configured network slices may include its own SMF 220, PCF 240, and UPF 215. Each of the NFs described above may be installed in, and be executed by, a network device residing in mobile network 110, or in another network (e.g., in an edge or a far edge network, not shown). A single network device may host and execute one or more of the NFs described above, and mobile network 110 may include at least one network device, or may have multiple (e.g., numerous) network devices that each host and execute one or more of the NFs described above.

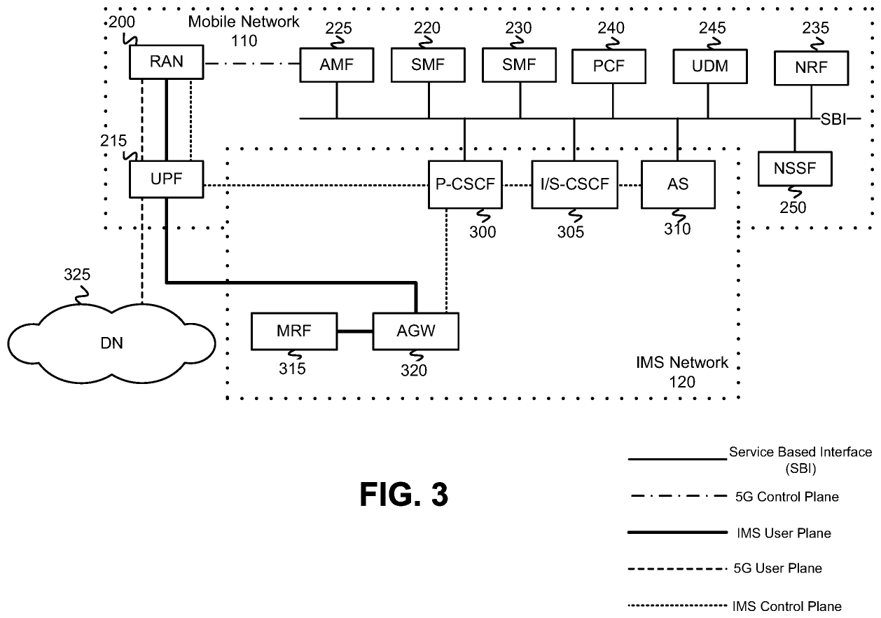

FIG. 3 illustrates an example of interfacing between mobile network 110 and NEs of IMS network 120. Existing IMS networks typically include an IMS core network that handles all of the different services in a same network and where all of the different services combine and intermingle as part of one whole network. Due to the overall complexities of the existing IMS network, it is very difficult to introduce new features and provide efficient mechanisms to provide differentiated service. When IMS network slices are configured and provisioned within IMS network 120, as described further herein, one or more NEs in each IMS network slice may interface with various NFs or components of mobile network 110 depending on the particular function(s) or operations performed by each particular NE of the IMS network slice. The interface from a NE of IMS network to a NF or component of mobile network 110 120 may, for example, be a control plane interface that interfaces with a NF or component of mobile network 110 that performs control plane functions, or a user plane interface that interfaces with a NF or component of mobile network 110 that performs user plane functions.

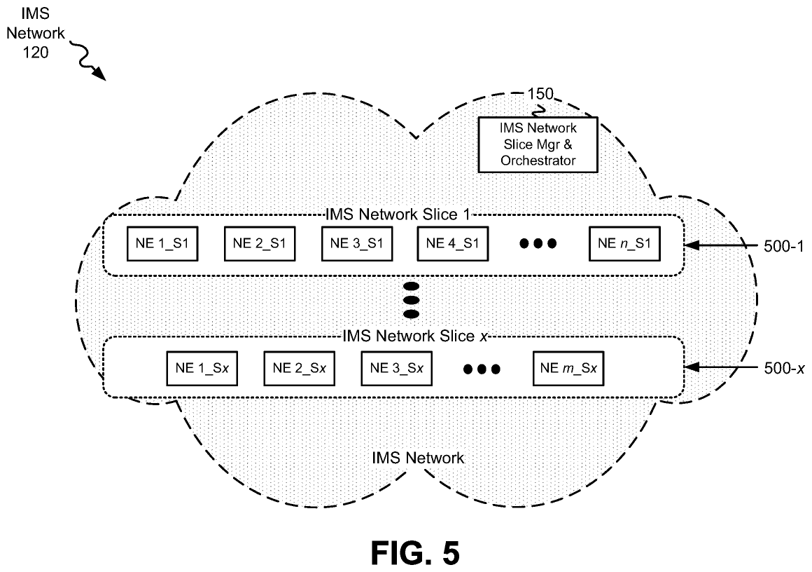

The example of FIG. 3 shows NEs of IMS network 120 (e.g., NEs of an IMS slice, such as described below with respect to FIG. 5) interfacing with NFs or components of mobile network 110 via either control plane interfaces or user plane interfaces, and also interfacing with other IMS NEs via control plane interfaces or user plane interfaces. The example IMS NEs, as shown, include a Proxy Call Session Control Function (P-CSCF) 300, an Interrogating and/or Serving CSCF (I/S-CSCF) 305, an application server (AS) 310, a Media Resource Function (MRF) 315, and an Access Gateway (AGW) 320.

The Call Session Control Functions (CSCFs) of IMS network 120 may include a number of different types of CSCFs that perform various functions related to establishment, modification, and termination of sessions within IMS network 120 (e.g., within an IMS slice of IMS network 120). P-CSCF 300 acts as a first point of contact within an IMS network slice of IMS network 120 and provides security and Quality of Service (QOS) functions. P-CSCF 300 may communicate with UPF 215 and I/S-CSCF 305 via IMS control plane interfaces. The S-CSCF acts as a main controller of sessions and interacts with a Home Subscriber Server (HSS) (not shown). The S-CSCF performs a number of functions, including handling SIP registrations, providing routing services (e.g., using E.164 Number Mapping (ENUM) lookups), and enforcing network operator policies. The S-CSCF may communicate with AS 310 and/or P-CSCF 300 via IMS control plane interfaces. The I-CSCF acts as a routing agent and directs incoming messages to an appropriate S-CSCF or P-CSCF 300. The I-CSCF may, for example, query the HSS to retrieve the address of the S-CSCF, assign it to a SIP registration, and forward SIP requests to the S-CSCF. The I-CSCF may communicate with P-CSCF 300, the S-CSCF, and/or AS 310 via IMS control plane interfaces.

AS 310 may perform one or more of various types of application services for sessions involving UEs 105. AS 310 may communicate with I/S-CSCF 305, using SIP, via an IMS control plane interface. Additionally, AS 310 may communicate with one or more NFs or components of mobile network 110 via a Service Based Interface (SBI), such as the SBI used by the NFs of mobile network 110 to communicate with one another.

MRF 315 may further include a Media Resource Function Controller (MRFC) and a Media Resource Function Processor (MRFP) (not shown). The MRFC controls the resources that are used to provide multimedia services to UEs 105. The MRFC selects the appropriate media resources for multimedia service delivery, including taking into account factors such as the type of service, QoS requirements, and the availability of media resources. The MRFC further controls the media resources during multimedia service delivery and ensures that the QoS requirements are met. The MRFP performs media processing functions such as audio and video transcoding, mixing, and playback, and further encodes, decodes, and streams media content during multimedia sessions.

AGW 320 acts as a gateway to enable the transmission of user plane data between MRF 315 and UPF 215 of mobile network 110 via an IMS user plane interface. AGW 320 may additionally communicate with P-CSCF 300 via an IMS control plane interface.

IMS network slices of IMS network 120 may each include a particular, customized set of NEs that may be different than those shown in FIG. 3. The NEs included in a particular IMS network slice may include, for example, a Subscriber Location Function (SLF), a Telephony Application Server (TAS), an IP Multimedia-Service Switching Function (IM-SSF), a Service Capability Interaction Manager (SCIM), a Breakout Gateway Control Function (BGCF), a Media Gateway Controller Function (MGCF), a Signaling Gateway (SGW), a Policy Decision Function (PDF), an IMS Gateway (IMS-GW), and/or a Border Gateway (BG). Other NEs not shown in FIG. 3, and not described herein, may be included in particular IMS network slices of IMS network 120.

A SLF may include a database that associates HSSs with particular user profiles (i.e., with particular UE users). The SLF may be used by NEs in IMS network 120 to find an appropriate HSS for a session involving a particular user. A TAS provides telephony applications and services, and possibly additional multimedia functions. A TAS may create and deliver a range of voice-based services. An IM-SSF enables the interconnection between IMS and non-IMS networks, allowing users to seamlessly access multi-media services from different networks. An IMS-SSF performs protocol translation between different signaling protocols used in different networks. A SCIM orchestrates service delivery, and operates as a service broker, among application servers within IMS network 120.

A BGCF provides a gateway between different types of networks, allowing communication between the different networks. A BGCF may act as a bridge between the Packet Switched (PS) domain and the Circuit Switched (CS) domain, and ensures that a call is correctly routed to a destination network. A MGCF facilitates call control and interfaces the PS domain to the CS domain when interworking between IMS network 120 and a Public Switched Telephone Network (PSTN) is needed. A MGFC may control one or more IMS Media Gateways (IMS-MGWs) and can be used in conjunction with a BGCF for calls to a PSTN or PLMN. A SGW provides a gateway that interfaces with the signaling plane of a CS network (e.g., a PSTN), and performs call control conversion between SIP and Integrated Services Digital Network User Part (ISUP) under the control of a MGFC.

A PDF performs decision making based on the policies defined for different services and applications in IMS network 120. An IMS-GW may act as a gateway between CSCFs and a PS network, such as an IP network, that performs session transport. An IMS-MGW interfaces with a media plane of a CS network, converting between different protocols. A BG acts as a gateway between a transport layer of the IMS network 300, and an external DN (e.g., DN 325).

The configuration of network components of IMS network 120 and mobile network 110 of FIG. 3 is for illustrative purposes. IMS network 120 shown in FIG. 3 represents just one example of the interfacing of NEs of IMS network 120 with NFs and/or components of mobile network 110. IMS network 120, including each IMS network slice of IMS network 120, may include different or additional NEs, arranged in a different configuration, than shown in FIG. 3, and may interface with mobile network 110 using different interfaces than those shown in FIG. 3.

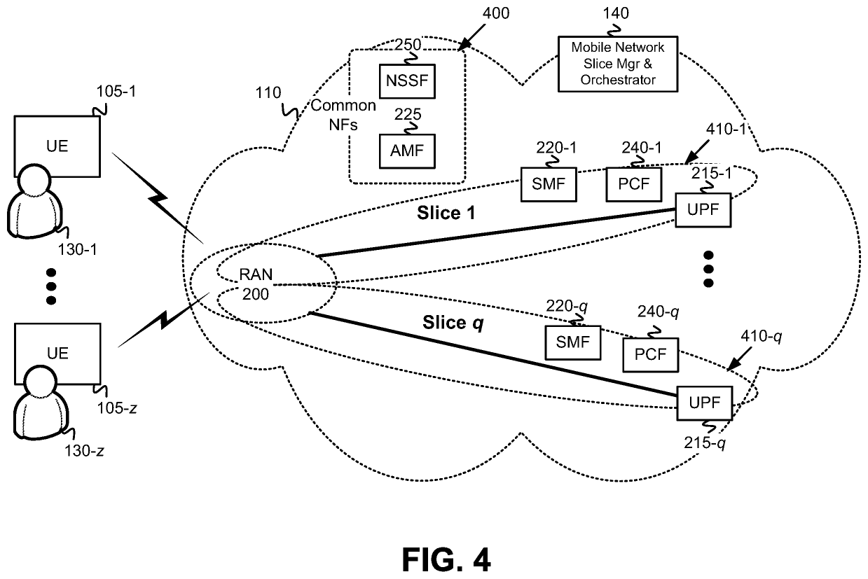

FIG. 4 illustrates an example of the implementation of network slices in mobile network 110. Each network slice of network slices 410-1 through 410-q may include a logical end-to-end network within mobile network 110, which may run on a shared physical infrastructure, that is created to serve a particular purpose and/or service data traffic with a particular set of performance parameters or characteristics. For example, each network slice of mobile network slices 410-1 through 410-q may service a particular service type and/or may satisfy or meet particular performance characteristics or parameters for sessions served by the network slice within mobile network 110.

As shown in FIG. 4, a group of common NFs 400 of mobile network 110 may service the different network slices 410-1 through 410-q (where q is greater than or equal to two) and, therefore, may not be considered to be included within the network slices 410-1 through 410-q. In the example shown, the common NFs 400 of mobile network 110 include an AMF 225 and a NSSF 250. Each network slice may include its own set of NFs, where each NF operates to service UE traffic sessions handled by that particular network slice. For example, as shown in FIG. 4, network slice 410-1 includes SMF 220-1, PCF 240-1, and UPF 215-1 that operate to service UE sessions within network slice 310-1. As a further example, network slice 410-q includes SMF 220-q, 240-q, and 215-q that operate to service UE sessions within network slice 210-q.

FIG. 5 depicts an example of the implementation of network slices in IMS network 120. Each network slice of IMS network slices 500-1 through 500-x may include a logical end-to-end network that IMS Network Slice Mgr & Orchestrator 150 creates, provisions, and orchestrates to perform a particular IMS service, or perform particular IMS functions and/or operations, with a particular set of associated performance parameters or characteristics. For example, each network slice of IMS network slices 500-1 through 500-x may service a particular IMS service type and/or may satisfy or meet particular performance characteristics or parameters for sessions served by the IMS network slice.

The ability to divide IMS network 120 into logical end-to-end IMS network slices, with each IMS network slice handling a particular service, has a number of advantages over the existing IMS network architecture. With IMS network slicing, each IMS slice can be linked to, and configured to work optimally with, a given Next Generation mobile network slice to provide an overall end-to-end network service defined, for example, for a particular user(s). Other advantages include simplifying the maintenance of each service and its IMS network slice, enabling the ability to provide differentiated service across multiple IMS network slices, and expediting the development of new enhancements for each service by reconfiguring, or making more localized changes, in an IMS network slice without having to make changes in the large IMS core network.

As shown in the example of FIG. 5, IMS network 120 may be configured, as described further herein, to have multiple IMS network slices 500-1 through 500-x. IMS network slice 500-1 (slice S1) may include n NEs (NE 1_S1, NE 2_S1, . . . , NE n_S1) that are configured to provide a first IMS service in IMS network 120, or to provide first IMS functions and/or operations, that may satisfy a set of performance parameters or characteristics. The set of performance parameters or characteristics of IMS network slice 500-1 may be the same as, or may be derived from, a set of performance parameters or characteristics of the mobile network slice with which IMS network slice 500-1 is linked in mobile network 110. The NEs of IMS network slice 500-1 may include any of the NEs shown in the IMS network 120 of FIG. 3, any of the other NEs associated with an IMS network described herein, and/or may include other NEs not specifically shown or described herein.

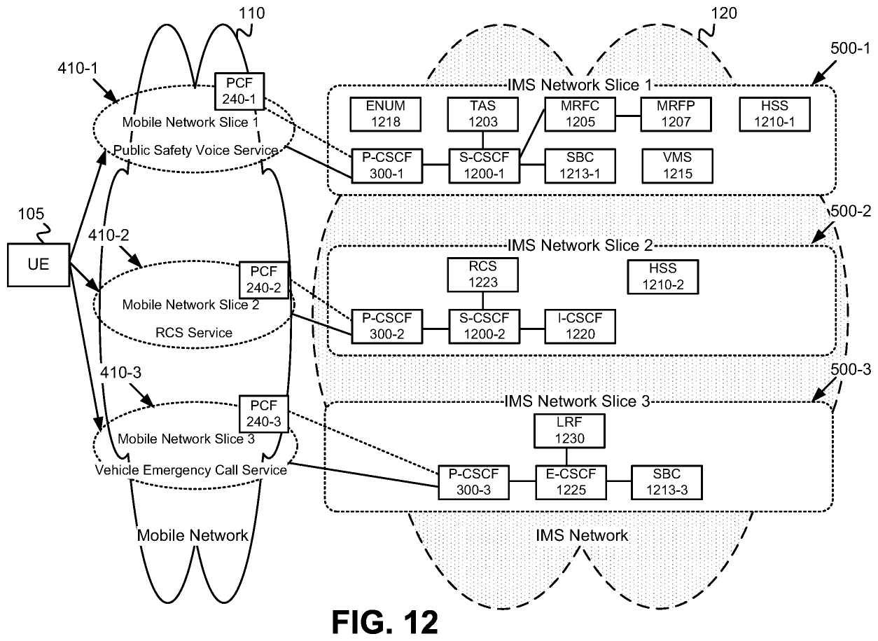

IMS network slice 500-x (Slice Sx) may further include m NEs (NE 1_Sx, NE 2_Sx, . . . , NE m_Sx) that are configured to provide a second IMS service in IMS network 120, or to provide second IMS functions and/or operations, that may satisfy a set of performance parameters or characteristics. The set of performance parameters or characteristics of IMS network slice 500-x may be the same as, or may be derived from, a set of performance parameters or characteristics of a mobile network slice with which IMS network slice 500-x is linked in mobile network 110. An example of multiple IMS network slices, including component NEs, and respective linked mobile network slices, are shown in, and described with respect to, FIG. 12 below. The NEs of IMS network slice 500-x may include any of the NEs shown in the IMS network 120 of FIG. 3, any of the other NEs associated with an IMS network described herein, and/or may include other NEs not specifically shown or described herein. As described further below, a network slicing ID (e.g., S-NSSAI) of each linked mobile network slice may be used in conjunction with configuration mapping tables to map the network slicing ID to one or more NEs within an IMS network slice that is linked to the mobile network slice that corresponds to the network slicing ID.

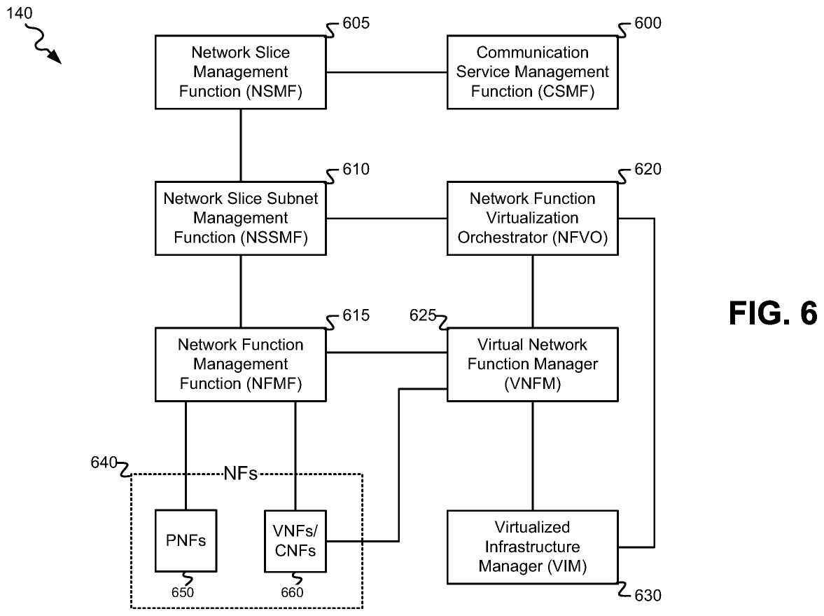

FIG. 6 illustrates example components of Mobile Network Slice Mgr & Orchestrator 140. IMS Network Slice Mgr & Orchestrator 150 may include the same, or similar components to those shown in FIG. 6. Mobile Network Slice Mgr & Orchestrator 140 may include, among other functions, a Communication Service Management Function (CSMF) 600, a Network Slice Management Function (NSMF) 605, a Network Slice Subnet Management Function (NSSMF) 610, a Network Function Virtualization Orchestrator (NFVO) 620, a Network Function Management Function (NFMF) 615, a Virtual Network Function Manager (VNFM) 625, a Virtualized Infrastructure Manager (VIM) 630, and Network Functions (NFs) 640. The functions of Mobile Network Slice Mgr & Orchestrator 140 may be executed by a single network device or may be executed by multiple network devices interconnected via a network and/or one or more links.

CSMF 600 includes NFs that provision and manage communication service instances within mobile network 110 (or in IMS network 120 in the case of IMS Network Slice Mgr & Orchestrator 150). CSMF 600 requests necessary resources to implement the communication service instances and carries out service assurance and Service Level Agreement (SLA) enforcement for each service instance in active operation.

NSMF 605 includes NFs that perform NSI monitoring, reporting, and life cycle management. NSMF 605, for example, performs network slice/NSI health monitoring, SLA assurance, and slice/NSI life cycle management. NSSMF 610 performs network slice subnet instance (NSSI) monitoring, reporting, and life cycle management. NSSMF 610, for example, performs alarm correlation and statistics aggregation at the slice subnet level, and NSSI life cycle management and provisioning according to the slice profile.

NFVO 620 includes NFs that perform resource and network service orchestration within mobile network 110. For resource orchestration, NFVO 620 oversees the allocation of resources and monitors the allocated resources. The resources may include compute resources (e.g., VNFs/CNFs 660), storage resources, and network resources. The network resources may include ports, subnets, forwarding rules, etc. needed for inter-VNF communications. For network service orchestration, NFVO 620 manages VNF/CNF deployment, creates and terminates links/networks between NFs, increases/decreases network service capacity, updates NF forwarding information, and instantiates VNFs/CNFs in coordination with VNFM 625.

NFMF 615 includes NFs that perform NF monitoring, reporting, and configuring. NFMF 615, for example, performs NF parameter configuration and provisioning. VNFM 625 includes NFs that perform life cycle management of VNFs/CNFs, including VNF/CNF instantiation, scaling of VNFs/CNFs, updating/upgrading of VNFs/CNFs, and termination of VNFs/CNFs. NFVO 620 coordinates with VNFM 625 to instantiate VNFs/CNFs and manage the deployment of network services that are provided by VNFs/CNFs. VNFM 625 further performs key performance indicator (KPI) monitoring. VIM 630 includes NFs that control and manage the NFV infrastructure (NFVI) compute resources, storage resources, and network resources in coordination with NFVO 620 and VNFM 625. NFs 640 may include Physical NFs (PNFs) 650 and VNFs/CNFs 660. PNFs 650 include physical network nodes which have not undergone virtualization. Both PNFs 650 and VNFs/CNFs 660 can be used to implement an overall network service. Each NE of IMS network 120 may be composed of a PNF 650 or a VNF/CNF 660.

The configuration of the components of Mobile Network Slice Mgr & Orchestrator 140 of FIG. 6 is for illustrative purposes. Other configurations may be implemented. Therefore, Mobile Network Slice Mgr & Orchestrator 140 may include additional, fewer and/or different components, arranged in a different configuration, than depicted in FIG. 6. IMS Network Slice Mgr & Orchestrator 150 may also include additional, fewer, and/or different components, arranged in a different configuration, than depicted in FIG. 6.

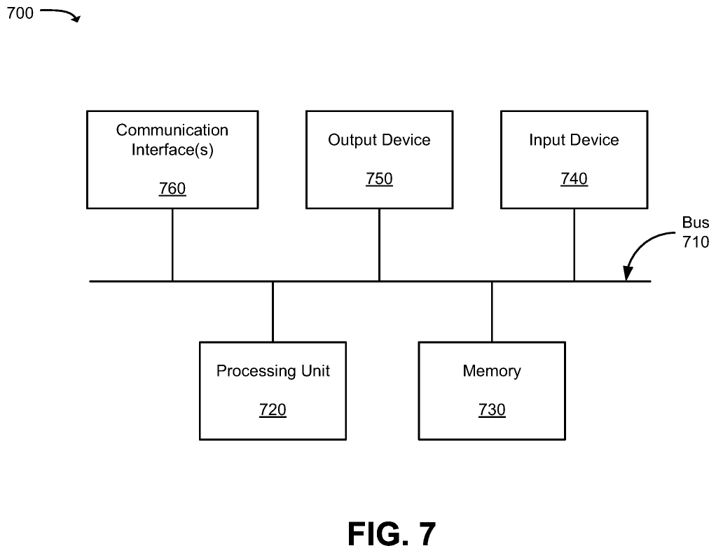

FIG. 7 is a diagram that depicts example components of a network device 700 (referred to herein as a “network device” or a “device”). UEs 105, Mobile Network Slice Mgr & Orchestrator 140, IMS Network Slice Mgr & Orchestrator 150, and the DUs, RUs, and/or CUs of the gNBs and eNBs of RAN 200 may include components that are the same as, or similar to, those of device 700 shown in FIG. 7. Furthermore, each of the mobile network functions UPF 215, SMF 220, AMF 225, AUSF 230, NRF 235, PCF 240, UDM 245, and NSSF 250 may be implemented by a device that includes components that are the same as, or similar to, those of network device 700. Some of the NFs UPF 215, SMF 220, AMF 225, AUSF 230, NRF 235, PCF 240, UDM 245, and NSSF 250 may be implemented by a same device 700 within mobile network 110, while others of the functions may be implemented by one or more separate devices 700 within mobile network 110. Mobile Network Slice Mgr & Orchestrator 140 and IMS Network Slice Mgr & Orchestrator 150 may be implemented by a same device 700 within mobile network 110 and/or IMS network 120, or may be implemented by different devices 700 within mobile network 110 and/or IMS network 120.

Device 700 may include a bus 710, a processing unit 720, a memory 730, an input device 740, an output device 750, and a communication interface 760. Bus 710 may include a path that permits communication among the components of device 700. Processing unit 720 may include one or more processors or microprocessors which may interpret and execute instructions, or processing logic. Memory 730 may include one or more memory devices for storing data and instructions. Memory 730 may include a random access memory (RAM) or another type of dynamic storage device that may store information and instructions for execution by processing unit 720, a Read Only Memory (ROM) device or another type of static storage device that may store static information and instructions for use by processing unit 720, and/or a magnetic, optical, or flash memory recording and storage medium. The memory devices of memory 730 may each be referred to herein as a “tangible non-transitory computer-readable medium,” “non-transitory computer-readable medium,” or “non-transitory storage medium.” In some implementations, the processes/methods (or portions, or blocks, of the processes/methods) set forth herein can be implemented as instructions that are stored in memory 730 for execution by processing unit 720.

Input device 740 may include one or more mechanisms that permit an operator to input information into device 700, such as, for example, a keypad or a keyboard, a display with a touch sensitive panel, voice recognition and/or biometric mechanisms, etc. Output device 750 may include one or more mechanisms that output information to the operator, including a display, a speaker, etc. Input device 740 and output device 750 may, in some implementations, be implemented as a user interface (UI) that displays UI information and which receives user input via the UI. Communication interface 760 may include a transceiver(s) that enables device 700 to communicate with other devices and/or systems. For example, communication interface 760 may include one or more wired and/or wireless transceivers for communicating via mobile network 110 or IMS network 120. In the case of gNBs 210 of RAN 200, communication interface 760 may further include one or more antenna arrays for generating radio frequency (RF) cells or cell sectors.

The configuration of components of network device 700 illustrated in FIG. 7 is for illustrative purposes. Other configurations may be implemented. Therefore, network device 700 may include additional, fewer and/or different components, that may be arranged in a different configuration, than depicted in FIG. 7.

FIG. 8 is a flow diagram of an example process for implementing a network slice in mobile network 110 and a corresponding, linked network slice in IMS network 120. The linked mobile network slice and IMS network slice may work in tandem with one another to provide an end-to-end network service that satisfies a set of performance requirements or characteristics. The example process of FIG. 8 may be implemented by Mobile Network Slice Manager & Orchestrator 140 in conjunction with IMS Network Slice Mgr & Orchestrator 150.

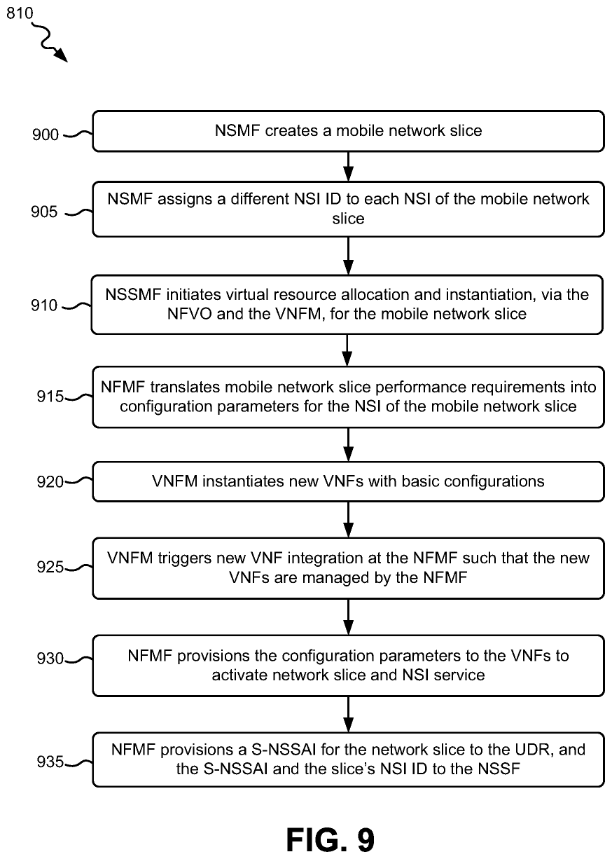

The example process includes identifying a service to be performed and its performance requirements (block 800). Various different types of service may be performed by a mobile network slice, such as, for example, transporting signaling and/or data traffic associated with a Public Safety Voice Service, a Rich Communications Service (RCS), or a Vehicle Emergency Call Service. Mobile Network Slice Mgr & Orchestrator 140 configures and provisions a mobile network slice for the identified service based on the performance requirements (block 810). Further details of mobile network slice configuring and provisioning are described below with respect to the example process of FIG. 9.

Mobile Network Slice Mgr & Orchestrator 140 provides an S-NSSAI of the provisioned mobile network slice to IMS Network Slice Mgr & Orchestrator 150 (block 820). The S-NSSAI value serves as a network slice identifier (ID) that uniquely identifies the mobile network slice and may include a Slice/Service Type (SST) value and a Slice Differentiator (SD) value (e.g., S-NSSAI=SST+SD). The SST may define the expected behavior of the network slice in terms of specific features and services. The SD value may be directly related to the SST value and may be used as an additional differentiator (e.g., if multiple network slices carry the same SST value). The S-NSSAI may be used within mobile network 110 and IMS network 120 for identifying and/or selecting a mobile network slice and linked IMS network slice for serving traffic (e.g., control plane traffic and/or user plane traffic) associated with a particular session. In addition to the network slice identifier ID, Mobile Network Slice Mgr & Orchestrator 140 may also provide an identification of the network service, and its associated performance requirements or characteristics, to IMS Network Slice Mgr & Orchestrator 150.

IMS Network Slice Mgr & Orchestrator 150 determines IMS network slice configuration data based on the identified service and its performance requirements (block 830). For each type of network service served by the IMS network slice, a particular set of NEs, each being of a particular NE type, may be required, with those types being arranged in a particular network configuration within the IMS network slice. The configuration data, thus, may include a configuration of the IMS network slice and its constituent NEs that may be determined based on the performance requirements of the identified service. IMS Network Slice Mgr & Orchestrator 150 configures and provisions an IMS network slice for the identified service based on the IMS network slice configuration data (block 840). Further details of the configuring and provisioning of the IMS network slice are described below with respect to the example process of FIG. 10.

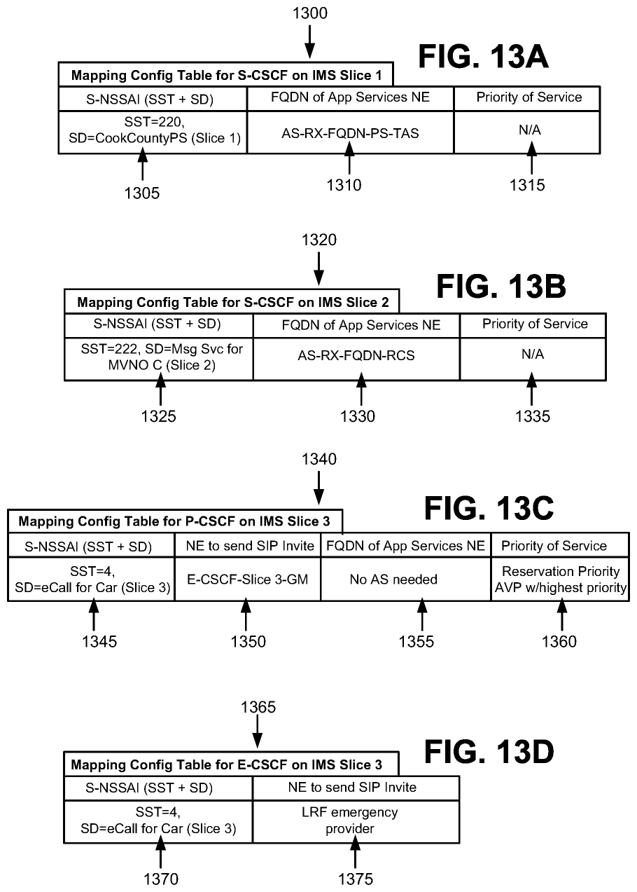

One or more blocks of the example process of FIG. 8 may be repeated, one or more times, to dynamically reconfigure an IMS network slice that is linked to a particular mobile network slice. Reconfiguring the IMS network slice may include adding NEs, deleting NEs, and/or modifying configuration parameters associated with already existing NEs of the IMS network slice. Reconfiguring the IMS network slice may additionally include re-generating mapping configuration tables, such as those described below with respect to the examples of FIGS. 11 and 13A-13D, for each NE of the reconfigured IMS network slice.

FIG. 9 is a flow diagram of example details of block 810 of FIG. 8 in which Mobile Network Slice Mgr & Orchestrator 140 configures and provisions a mobile network slice. The example process of FIG. 9 may be implemented by Mobile Network Slice Mgr & Orchestrator 140 for each mobile network slice to be created and configured within mobile network 110.

The example process includes NSMF 605 creating a mobile network slice (block 900). Each mobile network slice corresponds to a particular purpose and/or particular performance requirements. Creation of each mobile network slice includes instantiating, allocating, provisioning, and/or configuring a set of NF instances, and required resources (e.g., compute, storage, and networking resources), for serving the overall purpose and/or performance requirements (e.g., bandwidth, latency, etc.) of the mobile network slice. NSMF 605 designs and creates the mobile network slice.

NSMF 605 further assigns a different Network Slice Instance Identifier (NSI ID) to each NSI of the mobile network slice (block 905). A mobile network slice may be composed of one or more NSIs, and each NSI may include a set of NF instances and the required resources (e.g., compute, storage, and networking resources) to deploy at least a portion of a mobile network slice. In some implementations, a mobile network slice may be composed of multiple NSIs that each serve the particular purpose and/or performance requirements of the mobile network slice. NSSMF 610 initiates virtual resource allocation and instantiation, via the NFVO 620 and the VNFM 625, for the NSI of the mobile network slice (block 910). NSSMF 610 works in coordination with NFVO 620 and VNFM 625 to allocate and instantiate the virtual resources for the mobile network slice for servicing sessions within the requirements of the mobile network slice.

NFMF 615 translates slice performance requirements/parameters into configuration parameters for configuring the virtual network resources of the NSI of the mobile network slice (block 915). NFMF 615 determines, based on the allocated and instantiated virtual resources for the NSI, the configuration parameters for the virtual resources (e.g., compute, storage, and networking resources) that will assist in enabling the NSI(s) to satisfy the network slice performance requirements (e.g., SLAs) when servicing UE sessions.

VNFM 625 instantiates new VNFs and/or CNFs with basic configurations (block 920) and triggers new VNF integration at the NFMF 615 such that the new VNFs and/or CNFs are managed by the NFMF 615 (block 925). VNFM 625 determines what additional new VNFs and/or CNFs need to be instantiated within each the NSI to assist in satisfying the slice performance requirements, and then instantiates the new VNFs and/or CNFs, within the virtual resources, with basic configurations that can be provisioned, as described further below, with the configuration parameters determined in block 915.

NFMF 615 provisions the configuration parameters of block 915 to the VNFs and/or CNFs to activate network slice and NSI service (block 930), and further provisions a S-NSSAI for the network slice to the UDR of UDM 245, and the S-NSSAI and the network slice's NSI ID to the NSSF 250 (block 935). NFMF 615 assigns the mobile network slice the S-NSSAI value as a mobile network slice unique ID, and obtains the NSI ID(s) assigned in block 905. The S-NSSAI and NSI IDs, of the one or more NSIs within the network slice, may be used within mobile network 110 for network slice selection for servicing UE sessions.

NFMF 615, or NSSF 250, may further send the potentially supported network slicing information (e.g., updated and currently configured S-NSSAIs, NSI IDs, other network slicing information) to other nodes in mobile network 110 including, for example, to AMFs 225. Each AMF 225 may, in turn, send the potentially supported network slicing information (e.g., updated and currently configured S-NSSAIs, NSI IDs, other network slicing information) to, for example, UEs 105 currently active and connected to RAN 200 of mobile network 110. In one implementation, AMF 225 may “push” potentially supported network slicing information to UEs 105 at, for example, particular intervals (e.g., periodically) or upon an occurrence of a particular event. In another implementation, UEs 105 may “pull” potentially supported network slicing information from an AMF 225 by sending a request(s) to the AMF 225 (e.g., a registration request).

FIG. 10 is a flow diagram of example details of blocks 830 and 840 of FIG. 8 in which IMS Network Slice Mgr & Orchestrator 150 configures and provisions an IMS network slice. The example process of FIG. 10 may be implemented by IMS Network Slice Mgr & Orchestrator 150 for each IMS network slice to be created and configured within IMS network 120. A portion of the example process of FIG. 10 is described with additional reference to FIG. 11.

The example process includes NSMF 605 creating an IMS network slice, including determining a configuration of the IMS network slice and its constituent NEs (block 1000). Each IMS network slice performs a particular IMS service, or performs particular IMS functions and/or operations, and has particular performance requirements. Creation of each IMS network slice includes determining a configuration of the IMS network slice and the NEs of the slice that perform the functions/operations of the IMS network slice. Creation of each IMS network slice further includes instantiating, allocating, provisioning, and/or configuring a set of NF instances (e.g., VNFs and/or CNFs), and required resources (e.g., compute, storage, and networking resources), to implement the NEs that perform the functions/operations of the IMS network slice, while also satisfying the performance requirements (e.g., bandwidth, latency, etc.) of the IMS network slice. The NEs of the IMS network slice may, therefore, be purpose-built to perform a particular IMS service, or particular IMS functions and/or operations, while also satisfying particular performance requirements associated with the IMS network slice (and/or the linked mobile network slice). NSMF 605 creates the IMS network slice based on the IMS service to be performed and/or the performance requirements of the IMS service.

NSSMF 610 initiates virtual resource allocation and instantiation, via the NFVO 620 and the VNFM 625, for the IMS network slice and its NEs (block 1005). NSSMF 610 works in coordination with NFVO 620 and VNFM 625 to allocate and instantiate the virtual resources of the IMS network slice for servicing sessions within the requirements of the IMS network slice. In the IMS network 120, the virtual resources may include NEs that perform various functions or operations within the IMS network slice. The NEs may include, for example, a HSS, a CSCF (e.g., S-CSCF, I-CSCF, P-CSCF, and/or Emergency CSCF (E-CSCF)), a MRFC, a MRFP, a BGCF, a SGW, a MGCF, a SGW, an RCS function, a Session Border Controller (SBC), a LRF, or one or more application servers. The NEs may include other network entities, servers, and/or functions not described herein. In some circumstances, all, or some of, the NEs for an IMS network slice may need to be allocated and instantiated anew. In other circumstances, one or more of the NEs for the IMS network slice may already be instantiated and configured for use by other IMS network slices, for example. In these circumstances, those particular NE s may be “shared” among multiple IMS network slices.

NFMF 615 translates the performance requirements into configuration parameters for configuring the virtual network resources of the IMS network slice (block 1010). The IMS network slice's performance requirements (i.e., performance parameters or characteristics required to satisfy mobile network slice and/or IMS network slice objectives/purposes) may be the same as, or may be derived from, performance requirements of the linked mobile network slice that is identified by the S-NSSAI provided in block 820 of FIG. 8. NFMF 615 determines, based on the allocated and instantiated virtual resources for the IMS network slice, the configuration parameters for the virtual resources (e.g., compute, storage, and networking resources) that will assist in enabling the IMS network slice to satisfy the network slice performance requirements when servicing IMS traffic/sessions.

VNFM 625 instantiates new VNFs and/or CNFs with basic configurations (block 1015) and triggers new VNF/CNF integration at the NFMF 615 such that the new VNFs and/or CNFs are managed by the NFMF 615 (block 1020). VNFM 625 determines what additional new VNFs and/or CNFs need to be instantiated to assist in satisfying the IMS service and/or IMS network slice performance requirements, and then instantiates the new VNFs and/or CNFs, within the virtual resources, with basic configurations that can be provisioned, as described further below, with the configuration parameters determined in block 1010.

NFMF 615 provisions the configuration parameters of block 1010 to the VNFs and/or CNFs to activate the IMS network slice service (block 1025). NSMF 605 further generates one or more IMS mapping configuration tables for the IMS network slice based on the S-NSSAI, provided in block 820 of the example process of FIG. 8, and based on the determined configuration of the IMS network slice (e.g., determined in block 1000) (block 1030). For example, each IMS mapping configuration table may be used by a respective NE in the IMS network slice to, among other purposes, determine a next NE to which to send a Session Initiation Protocol (SIP) Invite message, to determine an address of an application services entity (e.g., application server) that serves the NE in the IMS network slice, and/or to determine service priority information. IMS Network Slice Mgr & Orchestrator 150 may store the IMS mapping configuration table(s) at a centralized location within IMS network 120 or mobile network 110 (or an external Data Network), or may provision each IMS mapping configuration table to a respective NE in IMS network 120 for local storage and usage.

When dynamically reconfiguring an IMS network slice created by executing blocks 1000-1030 of FIG. 10, one or more blocks of FIG. 10 may be repeated to instantiate and provision new VNFs/CNFs for the IMS network slice, and/or to modify configuration parameters for existing VNFs/CNFs of the IMS network slice. Reconfiguring the IMS network slice may additionally include repeating block 1030 to generate new, or updated, IMS mapping configuration tables for the IMS network slice.

FIG. 11 depicts an example of a mapping configuration table 1100 for a generic NE (NE_p) within an IMS network slice y. As shown, mapping configuration table 1100 includes a network slicing ID field 1105, a SIP invite destination field 1110, an application services NE address field 1115, and a service priority field 1120.

Network slicing ID field 1105 stores a S-NSSAI for a mobile network slice with which IMS network slice y is linked. The S-NSSAI may include an SST value and a SD value that, in combination, uniquely identifies the mobile network slice. SIP invite destination field 1110 identifies a next NE to which the NE_p within IMS network slice y is to send an SIP Invite message when establishing a call session. Application services NE address field 1115 identifies a network address (e.g., a Fully Qualified Domain Name (FQDN)) of an application server) that provides a service for IMS network slice y. Service priority field 1120 identifies a service priority for the IMS network slice y. Each mapping configuration table 1100 may include respective ones of the fields 1105, 1110, 1115, and 1120 that are relevant to the NE to which the table 1100 is directed. For example, if a NE is used in an IMS network slice that does not employ application services, then table 1100 for that NE may omit the application services NE address field 1115.

FIG. 12 illustrates multiple examples of IMS network slices 500 linked to, and designed to service traffic associated with, particular mobile network slices 410. In the example shown, mobile network 110 includes mobile network slice 410-1 which services Public Safety Voice Service traffic, mobile network slice 410-2 which services RCS traffic, and mobile network slice 410-3 which services Vehicle Emergency Call Service traffic. As further shown in FIG. 12, mobile network slice 410-1 is linked to IMS network slice 500-1 which includes purpose-built and configured IMS NEs for the Public Safety Voice Service. Mobile network slice 410-2 is further shown linked to IMS network slice 500-2 which includes purpose-built and configured IMS NEs for the RCS service. Mobile network slice 410-3 is also shown linked to IMS network slice 500-3 which includes purpose-built and configured IMS NEs for the Vehicle

### Emergency Call Service.

IMS network slice 500-1 includes multiple NEs, including a P-CSCF 300-1, a S-CSCF 1200-1, a TAS 1203, a MRFC 1205, a MRFP 1207, a HSS 1210-1, a Session Border Controller (SBC) 1213, a Voice Mail Service (VMS) 1215, and an ENUM function 1219. A PCF 240-1 in mobile network slice 410-1 may connect with P-CSCF 300-1 for signaling between PCF 240-1 and P-CSCF 300-1 (e.g., via the SBI of FIG. 3). SBC 1213 is a network function that, among other functions, secures signaling and media crossing the edge of IMS network 120. VMS 1215 is a network function that records, stores, and manages voice messages. ENUM 1218 is a network function that implements a protocol to map telephone numbers to domain names using the Domain Name System (DNS). ENUM 1218 enables the interoperability between different network domains, such as PSTN, SIP, and email. The NEs shown in FIG. 12, as being components of IMS network slice 500-1, inter-operate to facilitate performance of the Public Safety Voice Service in conjunction with mobile network slice 410-1.

IMS network slice 500-2 includes multiple NEs, including a P-CSCF 302, a S-CSCF 1200-2, an I-CSCF 1220, an RCS function 1223, and an HSS 1210-2. A PCF 240-2 in mobile network slice 410-2 may connect with P-CSCF 300-2 for signaling between PCF 240-2 and P-CSCF 300-2 (e.g., via the SBI of FIG. 3). RCS 1223 is a network function that implements a communication protocol that facilitates a text message system that is richer than conventional text messaging services, and enables the transmission of in-call multimedia. The NEs shown in FIG. 12, as being components of IMS network slice 500-2, inter-operate to facilitate performance of RCS service in conjunction with mobile network slice 410-2.

IMS network slice 500-3 further includes multiple NEs, including a P-CSCF 300-3, an E-CSCF 1225, an SBC 1213-3, and an LRF 1230. A PCF 240-3 in mobile network slice 410-3 may connect with P-CSCF 300-3 for signaling between PCF 240-3 and P-CSCF 300-3 (e.g., via the SBI of FIG. 3). E-CSCF 1225 handles emergency calls within IMS network 120. E-CSCF 1225 routes emergency calls to the appropriate Public Safety Answering Point (PSAP) that includes the call center responsible for handling emergency calls in a specific geographic area, and further provides information about the location of the caller. LRF 1230 retrieves location information for users/subscribers that have initiated an emergency session/call. The NEs shown in FIG. 12, as being components of IMS network slice 500-3, inter-operate to facilitate performance of a Vehicle Emergency Call Service in conjunction with mobile network slice 410-3.

FIGS. 13A-13D illustrate examples of mapping configuration tables associated with some of the NEs of the IMS network slices 500-1 through 500-3 shown in FIG. 12. Mapping configuration table 1300 of FIG. 13A shows fields for the NE S-CSCF 1200-1 in IMS network slice 500-1 of FIG. 12. As shown, table 1300 includes a network slicing ID (e.g., S-NSSAI) field 1305, a FQDN of App services NE field 1310, and a priority of service field 1315. Network slicing ID field 1305 identifies the S-NSSAI (including SST and SD) of mobile network slice 410-1 that is linked to the IMS network slice 500-1. FQDN of App services NE field 1310 identifies the FQDN of TAS 1203 in IMS network slice 500-2 to which traffic is routed from the S-CSCF 1200-1. Priority of service field 1315 identifies a particular priority level of service to be applied to traffic sent to TAS 1203 (in this particular example, N/A or none).

Mapping configuration table 1320 of FIG. 13B shows fields for the NE S-CSCF 1200-2 in IMS network slice 500-2 of FIG. 12. As shown, table 1320 includes a network slicing ID (e.g., S-NSSAI) field 1325, a FQDN of App services NE field 1330, and a priority of service field 1335. Network slicing ID field 1325 identifies the S-NSSAI (including SST and SD) of mobile network slice 410-2 that is linked to the IMS network slice 500-2. FQDN of App services NE field 1310 identifies the FQDN of RCS 1223 in IMS network slice 500-2 to which traffic is routed from the S-CSCF 1200-2. Priority of service field 1315 identifies a particular priority level of service to be applied to traffic sent to RCS 1223 (in this particular example, N/A or none).

Mapping configuration table 1340 of FIG. 13C shows fields for the NE P-CSCF 300-3 in IMS network slice 500-3 of FIG. 12. As shown, table 1340 includes a network slicing ID (e.g., S-NSSAI) field 1345, a NE to send SIP invite field 1350, a FQDN of App services NE field 135, and a priority of service field 1360. Network slicing ID field 1345 identifies the S-NSSAI (including SST and SD) of mobile network slice 410-3 that is linked to the IMS network slice 500-3. NE to send SIP invite field 1350 identifies E-CSCF 1225 as the next NE to which P-CSCF 300-3 sends SIP invites. FQDN of App services NE field 1355 identifies that no application services are needed for the Vehicle Emergency Call Service. Priority of service field 1360 identifies a particular priority level of service (e.g., a highest level of priority for emergency service) to be applied to traffic sent from E-CSCF 1225 of IMS network slice 500-3.

Mapping configuration table 1365 of FIG. 13D shows fields for the NEE-CSCF 1225 in IMS network slice 500-3 of FIG. 12. As shown, table 1365 includes a network slicing ID (e.g., S-NSSAI) field 1370, and an NE to send SIP invite field 1375. Network slicing ID field 1370 identifies the S-NSSAI (including SST and SD) of mobile network slice 410-3 that is linked to the IMS network slice 500-3. NE to send SIP invite field 1375 identifies LRF 1230 as the NE to which E-CSCF 1225 sends SIP invites.

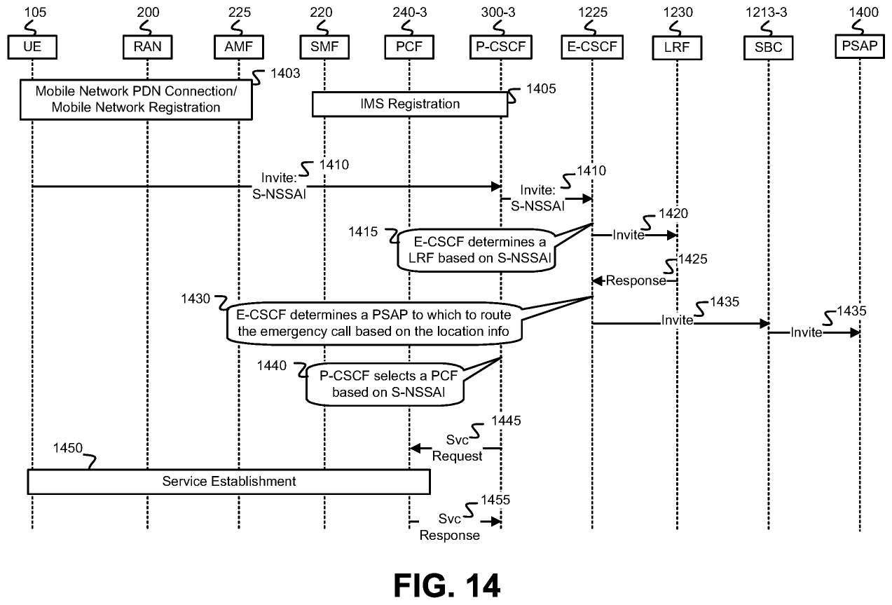

FIG. 14 depicts an example of a messaging diagram associated with establishing Vehicle Emergency Call Service via IMS network slice 500-3 of FIG. 12 using the network slicing ID (e.g., S-NSSAI) of the linked mobile network slice provisioned by the mobile network 110 in block 820 of FIG. 8. Prior to establishment of Vehicle Emergency Call Service via IMS network slice 500-3, UE 105 may first engage in a PDN connection establishment process and mobile network registration process 1403 with the mobile network 110 (e.g., involving RAN 200 and AMF 225), followed by IMS registration 1405 between mobile network 110 and IMS network 120. The mobile network registration process may include provision (e.g., by AMF 225 or NSSF 250) of at least one network slicing ID (e.g., an allowed and/or configured S-NSSAI) to UE 105 for the UE 105 to use for sending traffic over one or more network slices that carry traffic for a particular network service(s).

After establishment of the mobile network PDN connection, mobile network registration, and IMS registration, UE 105 may send a SIP Invite message 1410, to P-CSCF 300-3 of IMS network slice 500-3, that includes, among other data, a network slicing ID (e.g., S-NSSAI) of the mobile network slice of mobile network 110 that has been created, configured, and provisioned to serve the Vehicle Emergency Call Service. P-CSCF 300-3 forwards the SIP Invite message 1410 to E-CSCF 1225 which, in turn, determines a particular LRF 1230 based on the network slicing ID (e.g., S-NSSAI) received in the SIP Invite message 1410. E-CSCF 1225 may determine the particular LRF 1230, for example, by consulting mapping configuration table 1365 of FIG. 13D that may be stored locally at E-CSCF 1225. E-CSCF 1225 sends an SIP Invite message 1420 to the determined LRF 1230. LRF 1230 retrieves location information for the UE 105 that initiated the emergency session, and returns the location information in a Response message 1425 to E-CSCF 1225.

Upon receipt of the Response message 1425 from LRF 1230, that includes UE location information, E-CSCF 1225 determines 1430 (e.g., based on a lookup) a Public Safety Answering Point (PSAP) 1400 to which to route the emergency call using the location information. E-CSCF 1225 then sends a SIP Invite message 1435 to an appropriate SBC 1213-3, located at an edge of IMS network 120, which can forward the SIP Invite message 1435 to the destination PSAP 1400.

Subsequent to receipt of SIP Invite message 1410, that includes the network slicing ID (e.g., S-NSSAI), P-CSCF 300-3 selects 1440 a PCF 240 based on the network slicing ID. P-CSCF 300-3, for example, selects the PCF 240 (e.g., PCF 240-3) that is a component of the mobile network slice that is identified by the network slicing ID. P-CSCF 300-3 then sends a service request message 1445 to the selected PCF 240-3 of the mobile network slice. In response to the service request message 1445, PCF 240-3, SMF 220, AMF 225, and RAN 200 engage in a service establishment process 1450 with UE 105, upon completion of which PCF 240-3 returns a service response message 1455 to P-CSCF 345 to complete establishment of the Vehicle Emergency Call Service with UE 105.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 8-10, and sequences of operations, messages, and/or data flows with respect to FIG. 14, the order of the blocks and/or the order of the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 720) of a device. A non-transitory storage medium includes one or more of the storage mediums described in relation to memory 730. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving first performance requirements associated with a first network slice of a mobile network;
determining, based on the first performance requirements, first configuration data associated with a first Internet Protocol (IP) Multimedia Subsystem (IMS) network slice of an IMS network, wherein the first IMS network slice is linked to the first network slice of the mobile network; and
configuring and provisioning, based on the first configuration data, the first IMS network slice in the IMS network.

2. The method of claim 1, wherein determining the first configuration data further comprises:
translating the performance requirements into configuration parameters for the first IMS network slice.

3. The method of claim 2, wherein configuring and provisioning the first IMS network slice further comprises:
instantiating at least one of Virtual Network Functions (VNFs) or Cloud-Native Network Functions (CNFs) in the IMS network; and
provisioning the configuration parameters to the at least one of VNFs or CNFs.

4. The method of claim 1, further comprising:
receiving second performance requirements associated with a second network slice of the mobile network;
determining, based on the second performance requirements, second configuration data associated with a second IMS network slice of the IMS network, wherein the second IMS network slice is linked to the second network slice of the mobile network, of the IMS network; and
configuring and provisioning, based on the second configuration data, the second IMS network slice in the IMS network.

5. The method of claim 1, wherein the first IMS network slice comprises multiple first network elements (NEs) and further comprising:
receiving a network slicing identifier (ID) associated with the first network slice of the mobile network, and
wherein configuring and provisioning the first IMS network slice further comprises:
generating mapping configuration tables, based on the network slicing ID and the first configuration data, for the multiple first NEs of the first IMS network slice.

6. The method of claim 5, wherein generating the mapping configuration tables for the multiple first NEs further comprises:
generating a respective mapping configuration table for each of the multiple first NEs, wherein each mapping configuration table maps the network slicing ID to one or more other NEs of an IMS service implemented by the first IMS network slice.

7. The method of claim 5, wherein the mapping configuration tables link the first network slice of the mobile network to the multiple first NEs of the first IMS network slice.

8. A network device, comprising:
at least one communication interface configured to receive first performance requirements associated with a first network slice of a mobile network; and
at least one processor configured to:
determine, based on the first performance requirements, first configuration data associated with a first Internet Protocol (IP) Multimedia Subsystem (IMS) network slice of an IMS network, wherein the first IMS network slice is linked to the first network slice of the mobile network, and
configure and provision, based on the first configuration data, the first IMS network slice in the IMS network.

9. The network device of claim 8, wherein, when determining the first configuration data, the at least one processor is further configured to:
translate the performance requirements into configuration parameters for the first IMS network slice.

10. The network device of claim 9, wherein, when configuring and provisioning the first IMS network slice, the at least one processor is further configured to:
instantiate at least one of Virtual Network Functions (VNFs) or Cloud-Native Network Functions (CNFs) in the IMS network, and
provision the configuration parameters to the at least one of VNFs or CNFs.

11. The network device of claim 8, wherein the at least one communication interface is further configured to:
receive second performance requirements associated with a second network slice of the mobile network, and
wherein the at least one processor is further configured to:
determine, based on the second performance requirements, second configuration data associated with a second IMS network slice of the IMS network, wherein the second IMS network slice is linked to the second network slice of the mobile network, and
configure and provision, based on the second configuration data, the second IMS network slice in the IMS network.

12. The network device of claim 8, wherein the first IMS network slice comprises multiple first network elements (NEs) and wherein the at least one processor is further configured to:
receive a network slicing identifier (ID) associated with the first network slice of the mobile network, and
wherein, when configuring and provisioning the first IMS network slice, the at least one processor is further configured to:
generate mapping configuration tables, based on the network slicing ID and the first configuration data, for the multiple first NEs of the first IMS network slice.

13. The network device of claim 12, wherein the mapping configuration tables link the first network slice of the mobile network to the multiple first NEs of the first IMS network slice.

14. The network device of claim 12, wherein, when generating the mapping configuration tables for the multiple first NEs, the at least one processor is further configured to:
generate a respective mapping configuration table for each of the multiple first NEs, wherein each mapping configuration table maps the network slicing ID to one or more other NEs of an IMS service implemented by the first IMS network slice.

15. A non-transitory storage medium storing instructions executable by a network device, wherein the instructions cause the network device to:
receive first performance requirements associated with a first network slice of a mobile network;
determine, based on the first performance requirements, first configuration data associated with a first Internet Protocol (IP) Multimedia Subsystem (IMS) network slice of an IMS network, wherein the first IMS network slice is linked to the first network slice of the mobile network; and
configure and provision, based on the first configuration data, the first IMS network slice in the IMS network.

16. The non-transitory storage medium of claim 15, wherein the instructions to cause the network device to determine the first configuration data further comprise instructions to cause the network device to:
translate the performance requirements into configuration parameters for the first IMS network slice.

17. The non-transitory storage medium of claim 16, wherein the instructions to cause the network device to configure and provision the first IMS network slice further comprise instructions to cause the network device to:
instantiate at least one of Virtual Network Functions (VNFs) or Cloud-Native Network Functions (CNFs) in the IMS network; and
provision the configuration parameters to the at least one of the VNFs or CNFs.

18. The non-transitory storage medium of claim 15, wherein the instructions further cause the network device to:
receive second performance requirements associated with a second network slice of the mobile network;
determine, based on the second performance requirements, second configuration data associated with a second IMS network slice of the IMS network, wherein the second IMS network slice is linked to the second network slice of the mobile network; and
configure and provision, based on the second configuration data, the second IMS network slice in the IMS network.

19. The non-transitory storage medium of claim 15, wherein the first IMS network slice comprises multiple first network elements (NEs) and wherein the instructions further cause the
receive a network slicing identifier (ID) associated with the first network slice of the mobile network, and
wherein the instructions to cause the network device to configure and provision the first IMS network slice further cause the network device to:
generate mapping configuration tables, based on the network slicing ID and the first configuration data, for the multiple first NEs of the first IMS network slice.

20. The non-transitory storage medium of claim 19, wherein the instructions to cause the network device to generate the mapping configuration tables for the multiple first NEs further cause the network device to:
generate a respective mapping configuration table for each of the multiple first NEs, wherein each mapping configuration table maps the network slicing ID to one or more other NEs of an IMS service implemented by the first IMS network slice.
